(19) United States
(12) Patent Application Publication
(10) Pub. No.: US 2026/0278289 A1
(43) Pub. Date: Sep. 17, 2026

(54) INFORMATION PROCESSING DEVICE, CHECK METHOD, AND NON-TRANSITORY COMPUTER READABLE MEDIUM

(71) Applicant: NEC Corporation, Tokyo (JP)

(72) Inventors: Daichi IWATA, Tokyo (JP); Ryo Kato, Tokyo (JP); Kai Ishikawa, Tokyo (JP); Katsuma Horino, Tokyo (JP)

(73) Assignee: NEC Corporation, Tokyo (JP)

(21) Appl. No.: 19/440,975

(22) Filed: Jan. 6, 2026

(30) Foreign Application Priority Data
Mar. 14, 2025 (JP) 2025-041812

(51) Int. Cl. G06F 40/40; G06Q 10/105

(52) U.S. Cl. CPC G06F 40/40; G06Q 10/105

(57) ABSTRACT

An information processing device includes the data acquisition unit for acquiring an interview record recorded for a target interview to be checked, and a check unit for checking the interview record acquired by the data acquisition unit using a language model subjected to machine learning to enable natural language processing. The check result by the check unit can be used for decision-making based on the content of the target interview, and the like. The check result can further be utilized to facilitate automated decision making supported by machine learning.

### INCORPORATION BY REFERENCE

This application is based upon and claims the benefit of priority from Japanese patent application No. 2025-041812, filed on Mar. 14, 2025, the disclosure of which is incorporated herein in its entirety by reference.

### TECHNICAL FIELD

The present disclosure relates to an information processing device, a check method, and a check program.

### BACKGROUND ART

In a case where various interviews such as meetings and business negotiations are held, the contents thereof are often recorded as interview records. The interview record is used in applications such as, for example, organizing the contents of the interview, preparing the next action plan based on the result of the interview, reviewing the contents of the interview, sharing the contents of the interview with parties, and the like. In addition, although the interview record is generally created by a person, a technology for automatically generating the interview record using a computer is also known.

Examples of the technology related to utilization of the interview record include a meeting minute creation support device described in JP 2022-85495 A below. The meeting minute creation support device described in JP 2022-85495 A displays the speech text converted from the voice of the participant and the intention of the speech determined from the three-dimensional image in an overlapping manner on the three-dimensional image of the participant in a conference. As a result, it is possible to improve the efficiency of confirmation/correction work, by the person, of the meeting minute written and created by the computer.

### SUMMARY

As described above, the meeting minute creation support device of JP 2022-85495 A assumes that a person performs confirmation/correction work of the meeting minute. An example object of the present disclosure is to provide a technique that the check of an interview record to be automatically performed.

An information processing device according to an example aspect of the present disclosure includes a data acquisition means for acquiring an interview record recorded for a target interview to be checked, and a check means for checking the interview record acquired by the data acquisition means using a language model subjected to machine learning to enable natural language processing.

A check method according to an example aspect of the present disclosure, in which at least one processor executes data acquisition processing of acquiring an interview record recorded for a target interview to be checked, and check processing of checking the interview record acquired in the data acquisition processing using a language model subjected to machine learning to enable natural language processing.

A check program according to an example aspect of the present disclosure causes a computer to function as a data acquisition means for acquiring an interview record recorded for a target interview to be checked, and a check means for checking the interview record acquired by the data acquisition means by using a language model subjected to machine learning to enable natural language processing.

According to an example aspect of the present disclosure, the check of an interview record can be automatically performed.

### BRIEF DESCRIPTION OF THE DRAWINGS

FIG. 1 is a block diagram illustrating a configuration of an information processing device according to the present disclosure;

FIG. 2 is a flowchart illustrating a flow of a check method according to the present disclosure;

FIG. 3 is a block diagram illustrating a configuration of another information processing device according to the present disclosure;

FIG. 4 is a diagram illustrating a flow from generation to check of an interview record;

FIG. 5 is a diagram illustrating an example of data recorded in a Data Base (DB) that records various types of information related to a target interview;

FIG. 6 is a diagram illustrating an example of generating a report indicating a check result of an interview record;

FIG. 7 is a diagram illustrating another example of generating a report indicating a check result of an interview record;

FIG. 8 is a flowchart illustrating an example of processing executed by the information processing device illustrated in FIG. 3; and

FIG. 9 is a block diagram illustrating a configuration of a computer that functions as the information processing device according to the present disclosure.

### EXAMPLE EMBODIMENT

Hereinafter, example embodiments of the present invention will be exemplified. However, the present invention is not limited to the following exemplary example embodiments, and various modifications can be made within a scope described in the claims. For example, example embodiments obtained by appropriately combining techniques (some or all of things or methods) adopted in the following exemplary example embodiments can also be included in the scope of the present invention. Example embodiments obtained by appropriately omitting some of the techniques adopted in the following exemplary example embodiments can also be included in the scope of the present invention. Effects mentioned in the following exemplary example embodiments are examples of effects expected in the exemplary example embodiments, and do not define extension of the present invention. That is, example embodiments that do not provide the effects mentioned in each of the exemplary example embodiments described below can also be included in the scope of the present invention.

### FIRST EXEMPLARY EXAMPLE EMBODIMENT

A first exemplary example embodiment that is an example of the example embodiments of the present invention will be described in detail with reference to the drawings. The present exemplary example embodiment is a basic form of each exemplary example embodiment to be described below. An application range of each technique adopted in the present exemplary example embodiment is not limited to the present exemplary example embodiment. That is, each technique adopted in the present exemplary example embodiment can also be adopted in another exemplary example embodiment included in the present disclosure within a range in which no particular technical problem occurs. Furthermore, each technique illustrated in the drawings referred to for describing the present exemplary example embodiment can also be adopted in another exemplary example embodiment included in the present disclosure within a range in which no particular technical problem occurs.

### Configuration of Information Processing Device 1

A configuration of an information processing device 1 according to the present exemplary example embodiment will be described with reference to FIG. 1. FIG. 1 is a block diagram illustrating the configuration of the information processing device 1. As illustrated in FIG. 1, the information processing device 1 includes a data acquisition unit 101 and a check unit 102.

The data acquisition unit 101 acquires an interview record recorded for the target interview to be checked. The interview record may be created by a human or may be automatically or semi-automatically generated by a computer. In addition, a method of acquiring the interview record is optional. For example, the data acquisition unit 101 may acquire an interview record input to the information processing device 1 or may acquire an interview record from a device outside the information processing device 1.

Here, the “interview” means a dialogue performed by a plurality of participants, and those that involve a dialogue among a consultation, a conference, a meeting, a dialogue, a counseling, an examination by a doctor or the like, an interview, and the like are also included in the scope of the interview. The participants in the interview may include participants other than humans such as chatbots (those who are not human but participate in the dialogue in the interview are referred to as “participants”).

In addition, the “interview record” is a record recorded for the content of the dialogue in the interview, and can be also referred to as a dialogue record or the like. In addition, the interview record can also be rephrased as, for example, meeting minutes in a case where the target interview is a conference or a meeting, a medical record in a case where the target interview is a counseling or an examination, and an interview record in a case where the target interview is an interview.

The check unit 102 checks the interview record acquired by the data acquisition unit 101 using a language model machine-learned in such a way as to enable natural language processing. Here, the “language model” may be a model machine-learned in such a way as to enable natural language processing. For example, as the language model, a model generated for checking an interview may be used, or a general-purpose model that can be used for applications other than checking an interview may be used. As the language model, a model obtained by fine-tuning a general-purpose model for checking an interview may be used. For example, a Generative Pre-trained Transformer (GPT) model obtained by machine learning of a natural language, a Bidirectional Encoder Representations from Transformers (BERT) model obtained by machine learning of a natural language, or the like can also be used as the language model.

In addition, the above-described “check” means to check the contents, and can be rephrased as “check”, “evaluation”, “inspection”, and the like. The check of the interview record can be said to be a check of the target interview or a check of the speech and behavior of the participants of the target interview. In checking the interview record, it is not always necessary to input the interview record into the language model. For example, the check unit 102 may output a check result of the interview record by inputting an analysis result obtained by analyzing the interview record to the language model.

As described above, the information processing device 1 according to the present exemplary example embodiment adopts a configuration including the data acquisition unit 101 for acquiring the interview record recorded for the target interview to be checked, and the check unit 102 for checking the interview record acquired by the data acquisition unit 101 using the language model machine-learned in such a way as to enable natural language processing.

According to the above configuration, since the language model machine-learned in such a way as to enable natural language processing is used, an effect is obtained that the check of the interview record can be automatically performed. The check result by the check unit 102 can be suitably used, for example, for automatic updating of the interview record, decision-making based on the content of the target interview, and the like.

### Check program

The functions of the information processing device 1 described above can also be achieved by a program. A check program according to the present exemplary example embodiment causes a computer to function as: a data acquisition means for acquiring an interview record recorded for a target interview to be checked, and a check means for checking the interview record acquired by the data acquisition means by using a language model machine-learned in such a way as to enable natural language processing. According to this check program, an effect is obtained that the check of the interview record can be automatically performed.

### Flow of Check Method

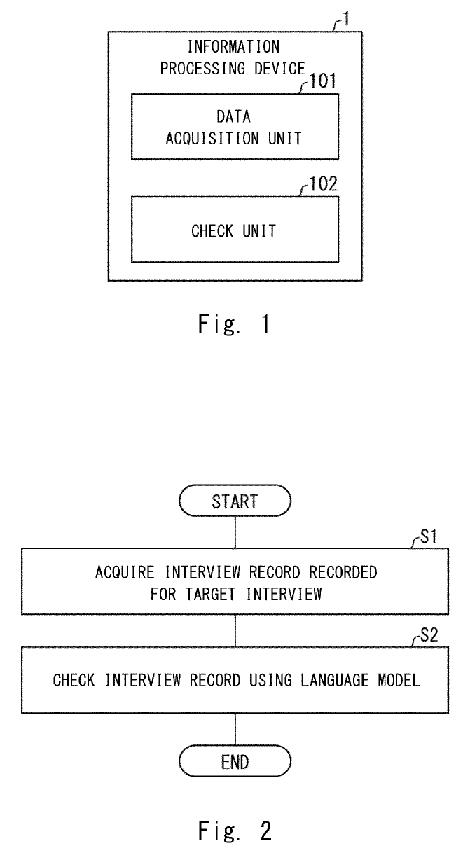

A flow of the check method according to the present exemplary example embodiment will be described with reference to FIG. 2. FIG. 2 is a flowchart illustrating a flow of a check method. An executing entity of each step in this check method may be a processor included in the information processing device 1 or may be a processor included in another device, or the executing entity of each step may be a processor provided in each of different devices.

In S1 (data acquisition processing), at least one processor acquires an interview record recorded for the target interview to be checked.

In S2 (check processing), at least one processor checks the interview record acquired in S1 (data acquisition processing) using a language model machine-learned in such a way as to enable natural language processing.

As described above, the check method according to the present exemplary example embodiment adopts a configuration in which at least one processor executes data acquisition processing of acquiring an interview record recorded for a target interview to be checked, and check processing of checking the interview record acquired in the data acquisition processing using a language model machine-learned in such a way as to enable natural language processing. According to this check method, an effect is obtained that the check of the interview record can be automatically performed.

### SECOND EXEMPLARY EXAMPLE EMBODIMENT

A second exemplary example embodiment that is an example of the example embodiments of the present invention will be described in detail with reference to the drawings. Components having the same functions as the components described in the above-described exemplary example embodiment are denoted by the same reference signs, and the description thereof will be appropriately omitted. An application range of each technique adopted in the present exemplary example embodiment is not limited to the present exemplary example embodiment. That is, each technique adopted in the present exemplary example embodiment can also be adopted in another exemplary example embodiment included in the present disclosure within a range in which no particular technical problem occurs. Each technique illustrated in each of the drawings referred to for describing the present exemplary example embodiment can be adopted in the other exemplary example embodiments included in the present disclosure within a range in which no particular technical problem occurs.

### Configuration of Information Processing Device 1A

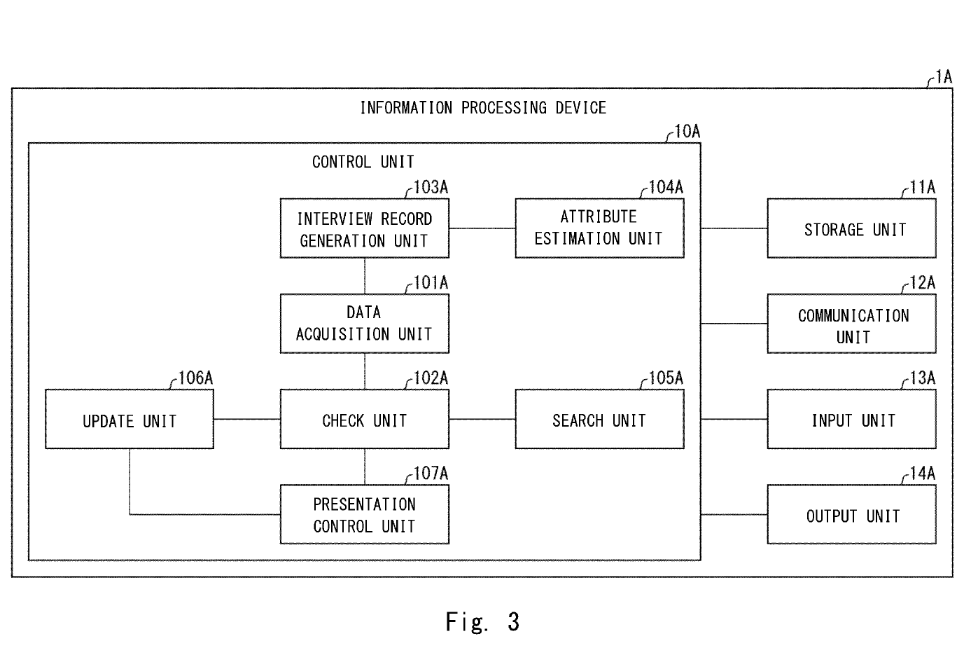

A configuration of an information processing device 1A according to the present exemplary example embodiment will be described with reference to FIG. 3. FIG. 3 is a block diagram illustrating a configuration of the information processing device 1A. The information processing device 1A is a device having a function of automatically performing the check of an interview record.

As illustrated, the information processing device 1A includes a control unit 10A for integrally controlling each unit of the information processing device 1A, and a storage unit 11A for storing various types of data to be used by the information processing device 1A. The information processing device 1A includes a communication unit 12A for the information processing device 1A to communicate with another device, an input unit 13A for receiving an input to the information processing device 1A, and an output unit 14A for the information processing device 1A to output data. The control unit 10A includes a data acquisition unit 101A, a check unit 102A, an interview record generation unit 103A, an attribute estimation unit 104A, a search unit 105A, an update unit 106A, and a presentation control unit 107A.

The data acquisition unit 101A acquires various types of data used by the information processing device 1A. For example, similarly to the data acquisition unit 101 of the first exemplary example embodiment, the data acquisition unit 101A acquires an interview record recorded for the target interview to be checked. In the present exemplary example embodiment, an example in which the data acquisition unit 101A acquires the interview record generated by the interview record generation unit 103A will be described.

Similarly to the check unit 102 of the first exemplary example embodiment, the check unit 102A checks the interview record acquired by the data acquisition unit 101A using a language model machine-learned in such a way as to enable natural language processing. Hereinafter, a model used for generating an interview record is referred to as a generation model 2A, and a language model used for checking by the check unit 102A is referred to as a language model 3A.

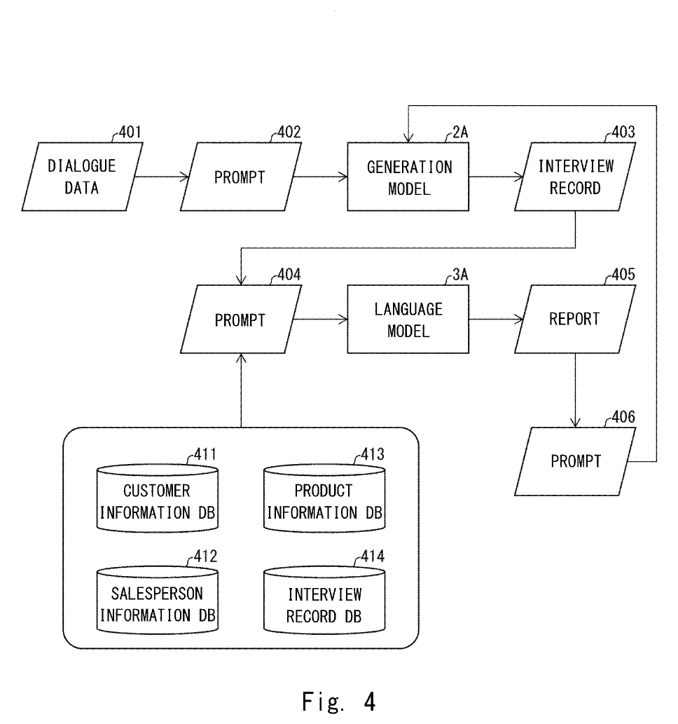

The interview record generation unit 103A generates an interview record. Although details will be described later with reference to FIG. 4, the interview record generation unit 103A generates an interview record indicating the content of the interview using the dialogue data indicating the contents of the dialogue in the interview and the generation model 2A.

The generation model 2A is a machine-learned model that generates an interview record according to an input instruction. The generation model 2A may be a model generated for generating an interview record, or may be a general-purpose model that can be used for applications other than generation of an interview record. In addition, the generation model 2A may be a model obtained by fine-tuning a general-purpose model for generating an interview record. Similarly to the language model described in the first exemplary example embodiment, for example, a GPT model obtained by machine learning of a natural language, a BERT model similarly obtained by machine learning of a natural language, or the like can be used as the generation model 2A. In addition, it is also possible to use the language model 3A as the generation model 2A, that is, to cause the language model 3A to generate an interview record.

The attribute estimation unit 104A estimates an attribute related to the interview. Specifically, the attribute estimation unit 104A analyzes the interview record to estimate the attribute related to the interview indicated in the interview record. An attribute to be estimated may be determined in advance. In addition, the estimation method is not particularly limited. For example, the attribute estimation unit 104A may estimate at least one of an attribute of a participant in the interview, an attribute of a matter that is a topic in the interview, and an attribute of the interview itself by analyzing the interview record using a natural language processing (NLP) technology. For example, the attribute estimation unit 104A may input the interview record to the language model 3A to cause the language model 3A to estimate the attribute, and the “attribute” can be rephrased as a characteristic, a feature, a property, or the like.

In a case where the attribute estimation unit 104A estimates the attribute of the participant in the target interview, the check unit 102A may cause the language model 3A to perform a check based on the attribute of the participant estimated by the attribute estimation unit 104A. As a result, in addition to the effect obtained by the information processing device 1, an effect is obtained that the check in consideration of the attribute of the participant in the target interview can be performed without trouble such as input of the attribute by the user.

The search unit 105A searches for an interview record of an associated interview related to the target interview. Although details will be described later, the search unit 105A may search for, for example, an interview record having common attributes estimated by the attribute estimation unit 104A. In this case, an interview having a common attribute with the target interview is an associated interview.

The update unit 106A updates the interview record in accordance with the result of the check by the check unit 102A. A method for updating the interview record will be described later with reference to FIG. 4.

The presentation control unit 107A presents various types of information to the user of the information processing device 1A. An aspect of the presentation is not particularly limited. For example, the presentation control unit 107A may present the information to the user by causing a display device to display and output the information. Furthermore, for example, the presentation control unit 107A may cause a voice output device to output information by voice, or may cause a printing device to print out information by printing. The device that outputs information may be included in the information processing device 1A or may be a device outside the information processing device 1A.

As described above, the information processing device 1A includes the data acquisition unit 101A for acquiring the interview record recorded for the target interview to be checked, and the check unit 102A for checking the interview record acquired by the data acquisition unit 101A using the language model 3A machine-learned in such a way as to enable natural language processing. Therefore, an effect is obtained that the check of the interview record can be automatically performed.

### Regarding Check of Interview Record

Various modes of checking the interview record using the language model 3A can be applied. For example, the check unit 102A may generate a prompt for instructing to check the interview record, and input the generated prompt to the language model 3A. As a result, it is possible to cause the language model 3A to output the check result of the interview record. Furthermore, the check unit 102A may check the interview record and generate a prompt for instructing to create a report summarizing the check results. In this case, it is possible to cause the language model 3A to output the check result in the report format. The “prompt” indicates the content of an instruction for the model, and can also be referred to as a command, a demand, a request, or the like.

In addition, the check unit 102A may generate a prompt including a check viewpoint. As a result, the language model 3A can be caused to output the check result from that viewpoint. For example, the check unit 102A can cause the language model 3A to check the content of the target interview, or can cause the language model 3A to check the format of the interview report. Specifically, the check unit 102A can also cause the language model 3A to check whether there is no problem in the speech and behavior of the participant in the target interview, whether there is an unclear portion in the interview record, whether there is missing information in the interview record, and the like. Furthermore, the check unit 102A can also cause the language model 3A to detect speech and behavior that are considered to have a problem among the speech and behavior of the participant in the target interview, a portion unclear in the interview record, information missing in the interview record, and the like.

Furthermore, the check unit 102A may generate a prompt including, as a check viewpoint, whether a response according to the attribute of the participant in the interview has been made. For example, the check unit 102A may generate a prompt for instructing to check from the viewpoint of whether the utterance of the utterer (e.g., a salesperson) in the target interview conforms to the attribute (e.g., psychological bias and behavioral characteristics) of the target person (customer). As a result, for example, it is also possible to give a high evaluation to an act of proposing a low-risk product, and give a low evaluation to an act of proposing a high-risk product to a customer having a risk avoidance tendency. The attribute of the participant in the interview may be estimated by the attribute estimation unit 104A, or may be input by the user.

Furthermore, the check unit 102A can also check the facticity of the utterance in the interview. In this case, the check unit 102A may cause the language model 3A to refer to data (e.g., data confirmed to be true or data provided from a reliable information source) for confirming the facticity, and cause the language model 3A to infer whether the utterance in the interview is the fact.

In this manner, the check unit 102A may cause the language model 3A to generate information indicating at least one of a check result of the content of the target interview, a check result of the format of the interview report of the target interview, or an improvement measure of the target interview. As a result, in addition to the effect obtained by the information processing device 1, an effect is obtained that at least one of the check result of the content of the target interview, the check result of the format of the interview report of the target interview, and the improvement measure of the target interview can be easily presented to the user. The “improvement measure” also includes a modification and the like. Furthermore, the information as described above is information for supporting the utilization of the interview record of the target interview, and can also be referred to as support information.

The improvement measure of the target interview can be used not only for feedback to the participants in the interview, but also for updating the interview record of the target interview, generation of the interview record of the next interview performed by the participants common to the target interview, and the like.

For example, it is assumed that the language model 3A outputs an improvement measure “different explanations are not given for the same product (contents of explanations for the same product are consistent)”. In this case, the presentation control unit 107A may present this improvement measure to a participant in the interview (more specifically, a person explaining a product) to call attention. Furthermore, in this case, the update unit 106A may generate a prompt for instructing to generate a detailed interview record regarding a viewpoint that “different explanations are not given for the same product”, and input the generated prompt to the generation model 2A. As a result, it is possible to set a detailed interview record for the viewpoint of “different explanations are not given for the same product” as the updated interview record. Furthermore, in this case, when checking the interview record of the interview after the target interview performed by the participant common to the subject interview, the check unit 102A may generate a prompt including whether “different explanations are not given for the same product” is satisfied as a check viewpoint, and input the generated prompt to the language model 3A. This makes it possible to easily check whether “different explanations are not given for the same product” has been achieved in the interview after the target interview.

In addition, the check unit 102A may cause the language model 3A to generate a prompt for instructing to generate an interview record based on the content of the target interview as a check result of the interview record of the target interview. In this case, the interview record generation unit 103A uses the generated prompt to cause the generation model 2A to generate an interview record for the next or subsequent interview to be held by the participant common to the target interview. As a result, in addition to the effect obtained by the information processing device 1, an effect is obtained that the content of the target interview can be reflected in the interview record of the next or subsequent interview.

For example, the check unit 102A may cause the language model 3A to generate a prompt for instructing to generate an interview record that includes an interview record of a target interview and that describes in detail a speech and behavior (e.g., an utterance about a product) related to a speech and behavior having a problem in the target interview (e.g., there is an error in the description of the product). As a result, whether appropriate follow-up has been made in the next interview for the speech and behavior having a problem in the target interview can be easily confirmed.

### Flow from Generation to Check of Interview Record

FIG. 4 is a diagram illustrating a flow from generation to check of an interview record by the information processing device 1A. In the example of FIG. 4, a prompt 402 is generated using dialogue data 401 indicating the content of the dialogue in the target interview, and the generated prompt 402 is input to the generation model 2A. As a result, the interview record 403 is output from the generation model 2A.

The dialogue data 401 is acquired by the data acquisition unit 101A. The dialogue data 401 may be generated, for example, by performing voice recognition on voice data obtained by recording the dialogue in the target interview. The voice recognition may be performed by the information processing device 1A or may be performed by another device. For example, the data acquisition unit 101A may generate the dialogue data 401 by acquiring voice data obtained by recording the dialogue in the target interview and performing voice recognition on the acquired voice data. In a case where the generation model 2A capable of generating an interview record from voice data or moving image data is used, the data acquisition unit 101A may acquire voice data or moving image data of the target interview as the dialogue data 401.

The prompt 402 is for instructing the generation of the interview record. The interview record generation unit 103A generates the prompt 402 using the dialogue data 401. For example, the interview record generation unit 103A may generate the prompt 402 by incorporating the dialogue data 401 into a predetermined template. As a specific example, the interview record generation unit 103A may generate, as the prompt 402, that in which the dialogue data 401 is incorporated in the portion of the “dialogue template” in the template of the content of sentence “Please create an interview record of the following dialogue. Dialogue content: [dialogue data]”.

The dialogue data 401 does not necessarily need to be incorporated in the prompt 402. For example, after inputting the dialogue data to the generation model 2A, the interview record generation unit 103A may input a prompt for instructing to create an interview record of the dialogue indicated in the dialogue data to the generation model 2A. Furthermore, for example, the interview record generation unit 103A may generate a prompt indicating a reference destination of the dialogue data 401 and input the prompt to the generation model 2A. In this case, the generation model 2A generates an interview record with reference to the dialogue data 401 recorded in the reference destination indicated in the prompt.

Furthermore, the interview record generation unit 103A may generate a prompt 402 in consideration of various types of information related to the target interview. For example, the interview record generation unit 103A may generate a prompt 402 including a sentence indicating participants of the target interview, a purpose of the target interview, an agenda of the target interview, and the like. Furthermore, for example, the interview record generation unit 103A may generate a prompt 402 including a sentence indicating a viewpoint to be considered in generating the interview record of the target interview. As a specific example, the interview record generation unit 103A may generate the prompt 402 including a sentence “The following dialogue is a dialogue between a sales representative of a securities company and a customer. Please create an interview record from the viewpoint of customer’s intention for investment, details of proposed product, explanation status of risks and important matters, and next action plan.”. By using the prompt 402 including various types of information related to the target interview in this manner, it is possible to cause the generation model 2A to generate the interview record 403 having appropriate contents according to the purpose of the target interview, the application of the interview record, and the like.

Furthermore, in the example of FIG. 4, a prompt 404 is generated using the interview record 403 generated as described above, and the generated prompt 404 is input to the language model 3A. In addition, in generating the prompt 404, a customer information database (DB) 411, a salesperson information DB 412, a product information DB 413, and an interview record DB 414 are referred to. Then, a report 405 is output from the language model 3A to which the prompt 404 has been input.

The prompt 404 is for instructing the check of the interview record. The check unit 102A generates the prompt 404 using the interview record 403. As with the prompt 402, the prompt 404 can also be generated using a predetermined template. For example, the check unit 102A may generate the prompt 404 incorporating the interview record 403 in the portion of “interview record” in the template of a content of sentence “Please check whether an appropriate interview has been conducted from the following interview record, and create a report indicating the check result. [Interview Record]”. It is not always necessary to incorporate the interview record 403 in the prompt 404, which is similar to the case of the prompt 402.

Furthermore, the check unit 102A may generate the prompt 404 in consideration of various types of information related to the target interview. For example, in a case where the target interview is a business negotiation between a salesperson and a customer, the check unit 102A may generate the prompt 404 in consideration of the customer information recorded in the customer information DB 411, the salesperson information recorded in the salesperson information DB 412, and the product information recorded in the product information DB 413. In addition, in a case where an associated interview associated with the target interview is detected from the interview record DB 414 by the search unit 105A, the check unit 102A may generate the prompt 404 in consideration of the associated interview. Details of each DB including the customer information DB 411 will be described later.

The report 405 indicates a check result of the interview record of the target interview, and is an example of support information for supporting utilization of the interview record. For example, the report 405 may indicate at least one of a check result of the content of the target interview, a check result of the format of the interview record, and an improvement measure of the target interview. The content to be included in the report 405 can be designated in the prompt 404.

For example, the language model 3A can be caused to generate the report 405 indicating a check result for the presence or absence of a compliance violation by using the prompt 404 for instructing to generate a report indicating a check result obtained by checking an interview record in terms of compliance violation. Similarly, by using the prompt 404 for instructing to generate a report indicating the check result obtained by checking the interview record from the viewpoint of whether there is a flaw in the form, it is possible to cause the language model 3A to generate the report 405 indicating the check result as to whether there is a flaw in the form. In addition, for example, by using the prompt 404 for instructing to generate a report indicating an improvement measure of the target interview, the language model 3A can be caused to generate the report 405 indicating the improvement measure of the target interview.

In addition, in the example of FIG. 4, a prompt 406 is generated using the report 405 generated as described above, and the generated prompt 406 is input to the generation model 2A. The prompt 406 is for instructing the generation of an interview record that reflects the check results indicated in the report 405. The update unit 106A generates the prompt 406 using the report 405. As with the prompts 402 and 404, the prompt 406 can also be generated using a predetermined template. For example, the update unit 106A may generate the prompt 406 incorporating the report 405 in the portion of “report” in the template of the content of sentence “The following report shows a check result of a certain interview record. Please create a prompt for generating a more appropriate interview record based on this check result. [report]”. It is not always necessary to incorporate the report 405 into the prompt 406 similarly to the case of the prompts 402 and 404.

The update unit 106A inputs the prompt 406 generated as described above to the generation model 2A. As a result, it is possible to cause the generation model 2A to generate a new interview record reflecting the result of the check by the check unit 102A. The generated new interview record can also be referred to as an updated interview record by the update unit 106A.

For example, in a case where the report 405 indicates that there is an utterance suspected of compliance violation, the update unit 106A may generate a prompt 406 for instructing to generate an interview record obtained by analyzing the utterance in more detail based on the flow of conversation before and after the utterance. As a result, the update unit 106A can input the prompt 406 to the generation model 2A to generate a new interview record including a more detailed analysis result regarding an utterance suspected of compliance violation.

As described above, the update unit 106A updates the interview record in accordance with the result of the check by the check unit 102A. As a result, in addition to the effect obtained by the information processing device 1, an effect is obtained that an interview record reflecting a check result can be automatically generated. Specifically, as described above, the update unit 106A may cause the generation model 2A to generate an interview record of a target interview by using a prompt for instructing generation of an interview record reflecting a result of the check by the check unit 102A, and may use the generated interview record as an updated interview record. This makes it possible to automatically generate an interview record reflecting the check result.

### Example of Data Used to Generate Prompt

As described above, various types of information regarding the target interview may be reflected in the prompt 404 for instructing to check the interview record of the target interview. In addition, these pieces of information may be acquired from each DB (specifically, the customer information DB 411, the salesperson information DB 412, the product information DB 413, and the interview record DB 414) illustrated in FIG. 4. As described above, the information acquired from these DBs is information used in a case where the target interview is a business negotiation between the salesperson and the customer.

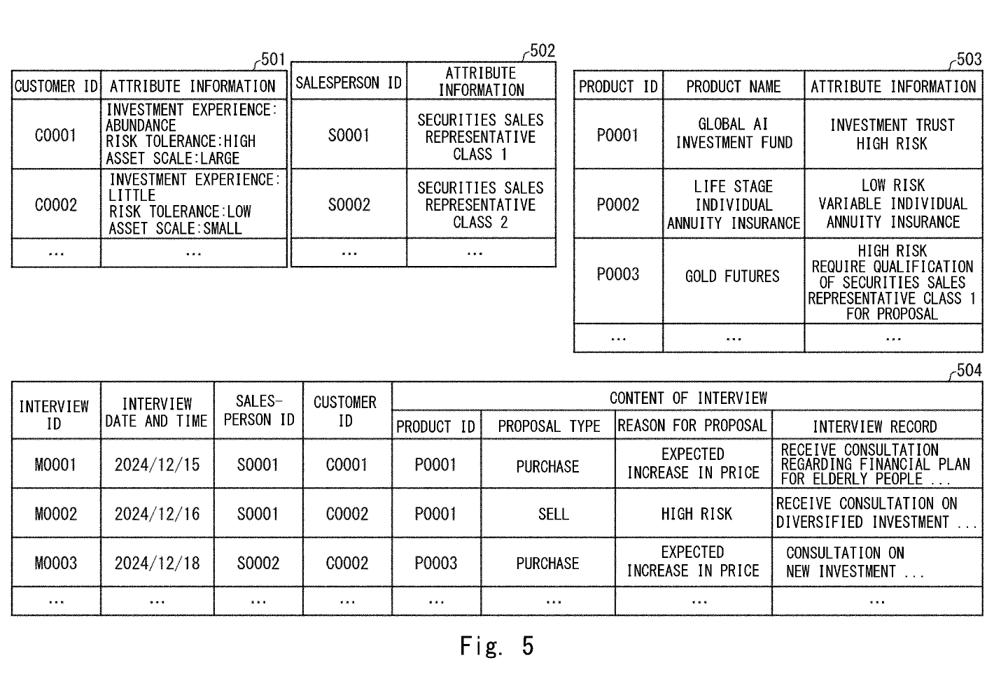

Hereinafter, an example of data recorded in each DB illustrated in FIG. 4 will be described with reference to FIG. 5. FIG. 5 is a diagram illustrating an example of data recorded in a DB that records various types of information regarding a target interview. Specifically, FIG. 5 illustrates customer data 501 recorded in the customer information DB 411, salesperson data 502 recorded in the salesperson information DB 412, product data 503 recorded in the product information DB 413, and interview data 504 recorded in the interview record DB 414.

The customer data 501 is data in which a customer identification (ID) that is identification information of a customer is associated with attribute information indicating an attribute of the customer. The check unit 102A can perform a check in consideration of the attribute of the customer by generating and using the prompt 404 reflecting the customer data 501. The attribute of the customer may be estimated by the attribute estimation unit 104A analyzing an interview record of an interview in which the customer has participated.

For example, in the customer data 501 illustrated in FIG. 5, as the attribute information of the customer with the customer ID C0001, it is indicated that investment experience is rich, risk tolerance is high, and the asset scale is large. Since these pieces of attribute information are information regarding asset management, the attribute information is useful if the target interview is a consultation regarding asset management. In this manner, it is preferable to use the customer data 501 associated with the content of the target interview and the like. For example, in a case where the target interview is a consultation regarding life insurance, it is preferable to use the customer data 501 including information regarding health such as a medical history of the customer.

In a case where the attribute information of the customer is included in the customer data 501, the check unit 102A may generate the prompt 404 for instructing to check the interview record on the assumption that the interview is with the customer having the attribute indicated in the attribute information. By inputting such a prompt 404 to the language model 3A, it is also possible to cause the language model 3A to output a check result from the viewpoint of whether the salesperson can appropriately respond to the customer having the above attribute, and the like.

The salesperson data 502 is data in which a salesperson ID that is identification information of a salesperson, is associated with attribute information indicating an attribute of the salesperson. The check unit 102A can perform a check in consideration of the attribute of the salesperson by generating and using the prompt 404 reflecting the salesperson data 502. Similarly to the customer data 501, it is preferable to use the salesperson data 502 according to the content of the target interview or the like.

For example, the salesperson data 502 illustrated in FIG. 5 indicates, as the attribute information of the salesperson with the salesperson ID S0001, that the salesperson has the qualification of Securities Sales Representative Class 1. In this case, the check unit 102A may generate the prompt 404 for instructing to check the interview record on the assumption that the salesperson has the qualification of Securities Sales Representative Class 1. By inputting such a prompt 404 to the language model 3A, it is also possible to cause the language model 3A to output a check result from the viewpoint of whether the salesperson can appropriately respond as a qualified person of Securities Sales Representative Class 1. Furthermore, the check unit 102A can also cause the language model 3A to output a check result from the viewpoint of whether an unqualified person is performing an action permitted only for a qualified person.

The product data 503 is data in which a product ID that is identification information of a product (typically, a product proposed by a salesperson to a customer or a product contracted by a customer) that has become a topic in the target interview, a product name, and attribute information indicating an attribute of the product are associated with each other. The check unit 102A can perform a check in consideration of the attribute of the product by generating and using the prompt 404 reflecting the product data 503. Similarly to the salesperson data 502 and the customer data 501, it is preferable to use the product data 503 according to the content of the target interview or the like.

For example, the product data 503 illustrated in FIG. 5 indicates that the product has a high risk as the attribute information of the product having the product ID of S0001. In this case, the check unit 102A may generate the prompt 404 for instructing to check the interview record on the assumption that the interview is for a product having a high risk. By inputting such a prompt 404 to the language model 3A, it is also possible to cause the language model 3A to output a check result from the viewpoint of whether the salesperson has made an appropriate proposal for a product with a high risk or the like.

The interview data 504 includes interview records for a plurality of interviews including the target interview. Specifically, in the interview data 504, the date and time of the interview, the salesperson ID of the salesperson participating in the interview, the customer ID of the customer participating in the interview, and information indicating the content of the interview are associated with each interview ID that is identification information of the interview. In addition, in the interview data 504, a product ID, a proposal type, and a proposal reason of a product that has become a topic are indicated as information indicating the content of the interview. The proposal type is information indicating what kind of proposal has been made for the product. For example, in the case of a financial product, a proposal to purchase, a proposal to sell, or the like corresponds to the proposal type. It can be said that the proposal type indicates the attribute of the interview, and it is also possible to cause the attribute estimation unit 104A to estimate the proposal type.

The interview record does not need to be managed as the interview data 504 including various types of data related to the interview as described above, and various types of data related to the interview and the interview record may be individually managed. Furthermore, the interview record generation unit 103A may generate a first interview record describing the content of an interview in sentences, and then extract main points from the generated first interview record to generate a second interview record. Furthermore, the interview record generation unit 103A may generate a second interview record (obtained by extracting the main points of an interview) without going through the first interview record. Both generation of these interview records and extraction of the main points from the interview records can be performed using the generation model 2A.

Furthermore, the interview record generation unit 103A may analyze the interview record using another NLP technology to estimate important information (e.g., a product being discussed, a participant of an interview, or the like) in the target interview. Then, the interview record generation unit 103A may record the estimation result as a main point of the interview record together with the interview record described in sentences or instead of the interview record described in sentences. The main points of the interview can be used, for example, as a search word in the search by the search unit 105A.

In a case where the interview data 504 is available, the search unit 105A searches for the interview record of the associated interview associated with the target interview from the interview data 504. What kind of interview to set as the associated interview may be defined in advance. For example, conditions such as a product being discussed is common, person in charge is common, customer is common, and interview date is close may be set in advance, and an interview satisfying the set conditions may be set as an associated interview. A plurality of conditions may be set.

For example, assume that the interview with the interview ID M0001 in the interview data 504 is a target interview. In addition, an interview in which a product being discussed is common among the interviews conducted by the same salesperson at intervals of within three days is assumed as an associated interview. In this case, the search unit 105A identifies, from the interview data 504, that the date and time of the target interview whose interview ID is M0001 is Dec. 15, 2024, the salesperson ID of the salesperson for the target interview is S0001, and the product ID of the product that has become a topic in the target interview is P0001. Then, the search unit 105A searches for, from the interview data 504, an interview record of an interview held within three days before and after Dec. 15, 2024, in which the salesperson ID is S0001 and the product ID is P0001. According to this search, the interview record for the interview with the interview ID M0002 is detected.

The check unit 102A causes the language model 3A to refer to the interview record of the associated interview detected by the search unit 105A as described above and the interview record of the target interview to generate a check result of checking the interview record of the target interview from the viewpoint of comparison with the associated interview. For example, the check unit 102A can also cause the language model 3A to check the target interview from the viewpoint of consistency between the speech and behavior in the target interview and the speech and behavior in the associated interview.

### Use Case 1

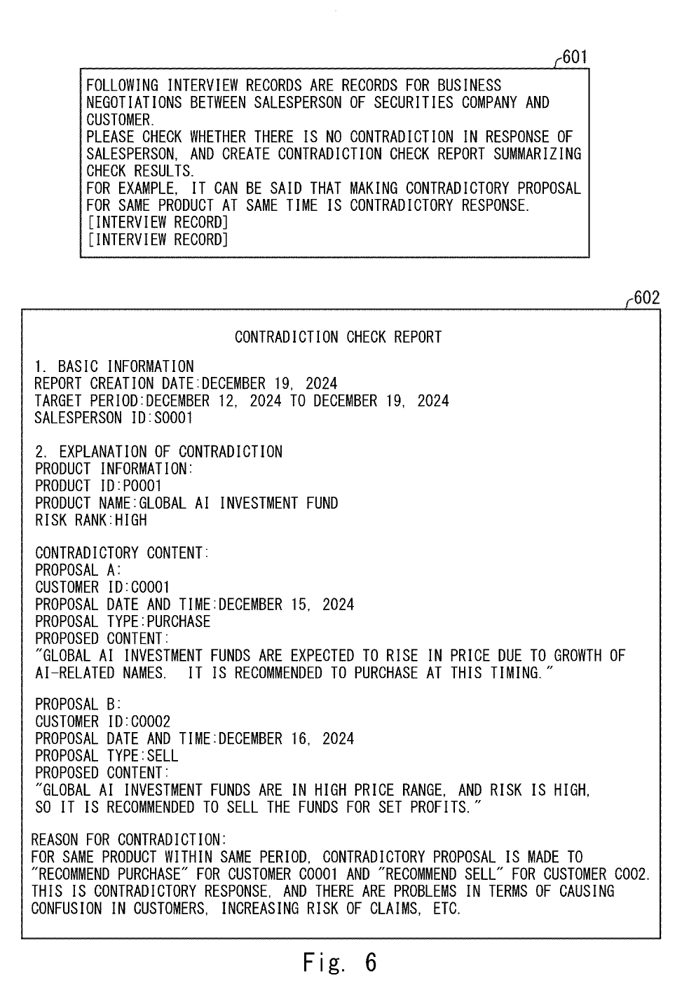

A use case of the information processing device 1A in the present example embodiment will be described with reference to FIG. 6. FIG. 6 is a diagram illustrating an example of generating a report indicating a check result of an interview record. More specifically, FIG. 6 illustrates, for a business negotiation between a salesperson who is a sales representative of a securities company and a customer, a prompt 601 for instructing generation of a report indicating a check result of an interview record of the business negotiation and a report 602 generated by inputting the prompt 601 to the language model 3A.

The prompt 601 has a content instructing to check whether there is a contradiction in the response of the salesperson with respect to a plurality of interview records recorded for the business negotiation between the salesperson of the securities company and the customer, and create a report summarizing the check results. In addition, an example of a contradictory response is described in the prompt 601. Including the specific example in the prompt 601 as described above is effective in generating a report with desired content. The prompt 601 also includes a plurality of interview records. One of the plurality of interview records is an interview record of a target interview, and the other is an interview record detected by the search unit 105A, that is, an interview record of an associated interview.

The portion other than “[Interview Record]” in the prompt 601 is a fixed phrase. Therefore, the check unit 102A can generate the prompt 601 by incorporating the interview records of the target interview and the associated interview in the fixed template. The interview record to be incorporated in the prompt 601 may describe the content of the interview in sentences or may extract the main points of the interview. The interview record merely needs to be referred to by the language model 3A in some form, and does not necessarily need to be incorporated in the prompt 601.

The report 602 is a document summarizing results of checking whether there is a contradiction in the response of the salesperson, and is generated by the language model 3A as described above. The report 602 indicates, as “basic information”, a creation date of the report 602, a period to be checked, and a salesperson ID of a salesperson who is estimated to have made a contradictory response. The provision of the item of the basic information in the report 602 and what information is described as the basic information may be designated in the prompt 601. The same applies to the following items.

In addition, in the report 602, as “explanation of contradiction”, the product information of the product for which the contradictory explanation has been made, the contradictory content (specifically, details of the two matters determined to be contradictory are as follows), and the reason for the contradiction are indicated.

For example, it is possible to generate a description of product information and contradictory content in the report 602 by causing the language model 3A to refer to the data such as by incorporating an interview record of an associated interview and a target interview extracted from the interview data 504 illustrated in FIG. 5 into the prompt 601 and the like. Furthermore, the reason for the contradiction can be inferred by the language model 3A by giving the above information to the language model 3A.

As described above, the search unit 105A searches for the interview record of the associated interview associated with the target interview. Then, the check unit 102A causes the language model 3A to perform a check based on the interview record of the associated interview detected by the search unit 105A. As a result, in addition to the effects obtained by the information processing device 1, an effect is obtained that a check in consideration of the contents of the associated interview can be performed. For example, as described above, the check unit 102A may cause the language model 3A to perform a check from the viewpoint of consistency between the speech and behavior in the target interview and the speech and behavior in the associated interview. As a result, in addition to the effect obtained by the information processing device 1, an effect is obtained that a check on whether the speech and behavior in the target interview and the speech and behavior in the associated interview are consistent can be facilitated.

The check unit 102A can also generate the report 602 indicated by the improvement measure associated with the content of the detected contradiction (in other words, inconsistency). For example, the check unit 102A can also cause the language model 3A to generate advice such as “For the same product, let’s make a coherent proposal even if the customer changes”.

### Use Case 2

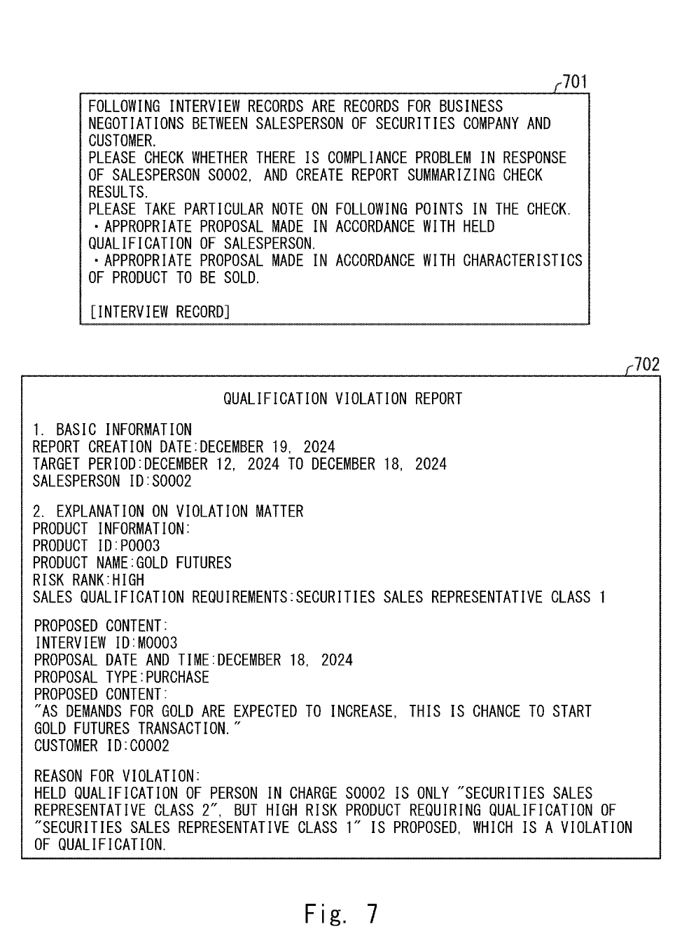

Another use case of the information processing device 1A in the present example embodiment will be described with reference to FIG. 7. FIG. 7 is a diagram illustrating another example of generating a report indicating a check result of an interview record. More specifically, FIG. 7 illustrates, for a business negotiation between a salesperson of a securities company and a customer, a prompt 701 for instructing generation of a report indicating a check result of an interview record of the business negotiation and a report 702 generated by inputting the prompt 701 to the language model 3A.

The prompt 701 has a content instructing to check whether there is a compliance problem in the response of the salesperson for the interview record of the business negotiation between the salesperson of the securities company (salesperson with the salesperson ID of S0002) and the customer, and create a report summarizing the check results. Furthermore, in the prompt 701, two points, that is, whether a proposal according to the qualification held is made and whether a proposal according to the characteristic of the product is made are described as viewpoints in the check (also referred to as point to be checked, etc.). Including the viewpoint of the check in the prompt 701 as described above is effective in generating a report having desired contents.

The prompt 701 also includes an interview record of the target interview. Although only one interview record is included in the prompt 701 of FIG. 7, if the salesperson to be checked has had a plurality of interviews, the interview record for each interview may be included in the prompt 701. In addition, an interview record of each interview performed during a predetermined period may be included in the prompt 701 without designating a salesperson to be checked. In this case, a report 702 is generated for an interview in which the salesperson’s response is suspected of having a compliance problem among the interviews performed during the predetermined period.

The portion other than “[Interview Record]” in the prompt 701 is a fixed phrase. Therefore, the check unit 102A can generate the prompt 701 by incorporating the interview records of the target interview in the fixed template. The interview record to be incorporated in the prompt 701 may describe the content of the interview in sentences or may extract the main points of the interview. The interview record merely needs to be referred to by the language model 3A in some form, and does not necessarily need to be incorporated in the prompt 701.

The report 702 is a document summarizing results of checking whether there is a compliance problem in the response of the salesperson, and is generated by the language model 3A as described above. In the example of FIG. 7, since it was estimated that a product proposal made by a salesperson who does not have the necessary qualification is a compliance problem, the title of the report 702 is “qualification violation report”. The title of the report 702 may be determined by the language model 3A or may be designated in the prompt 701.

In addition, the report 702 includes, as “basic information”, a creation date of the report 702, a period during which an interview (target interview) to be checked is conducted, and a salesperson ID of a salesperson who is estimated to have made a response having a compliance problem. The provision of the item of the basic information in the report 702 and what information is described as the basic information may be designated in the prompt 701. The same applies to the following items.

In addition, in the report 702, product information of a product related to a compliance problem, contents of a proposal for which a compliance problem has been estimated, and a reason for estimating the violation are indicated as “explanation on violation matter”. For an interview for which a violation is estimated to have occurred, it is preferable to explicitly instruct in the prompt 701 to always include such explanation in the report 702.

In a case where the language model 3A is caused to generate the report 702, the check unit 102A may, for example, incorporate an interview record of the target interview extracted from the interview data 504 illustrated in FIG. 5 into the prompt 701. Then, in generating the report 702, the check unit 102A may cause the language model 3A to refer to the salesperson data 502 (specifically, the holding qualification indicated in the attribute information of the salesperson with the salesperson ID of S0002) and the product data 503 (specifically, information regarding the qualification indicated in the attribute information of the product (product with ID P0003) proposed in the target interview) illustrated in FIG. 5. As a result, the product information and the description of the proposed content in the report 702 can be generated. In addition, the reason for the violation can be inferred by the language model 3A by giving the above-described information to the language model 3A.

The check unit 102A can also generate the report 702 indicating an improvement measure related to the content of the detected problem. For example, the check unit 102A can also cause the language model 3A to generate advice such as “In a case of recommending a futures transaction such as gold futures, ask a qualified person of Securities Sales Representative Class 1 to be present”.

In addition to the presence or absence of qualification or instead of the presence or absence of qualification, it is also possible to check the consistency between a risk rank indicating a high risk of a proposed product and a risk rank of a product that can be sold by a salesperson who has proposed the product. In this case, the risk rank (e.g., “high risk” and “low risk” in the product data 503 of FIG. 5) may be recorded as the attribute information of each product in the product data 503, and the risk rank of the product that can be sold by each salesperson may be recorded as the attribute information in the salesperson data 502. By causing the language model 3A to refer to these pieces of information, it is possible to cause the language model 3A to check whether each salesperson has performed a transaction within a permitted transaction range.

### Flow of Processing

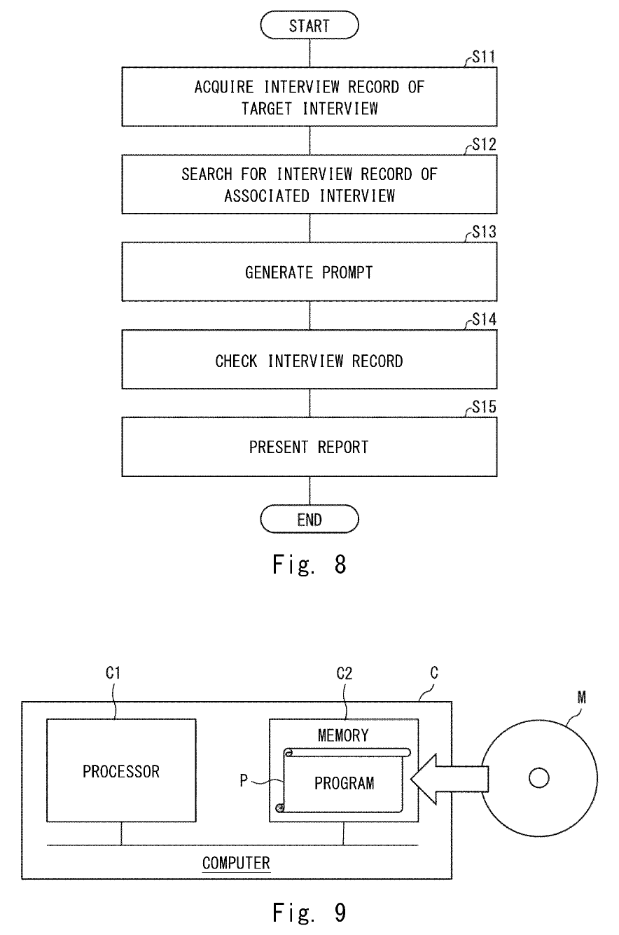

A flow of processing executed by the information processing device 1A will be described with reference to FIG. 8. FIG. 8 is a flowchart illustrating an example of the processing performed by the information processing device 1A. The flowchart of FIG. 8 includes each processing of the check method according to the present exemplary example embodiment. Before the processing of FIG. 8 is performed, the interview record generation unit 103A generates an interview record of a plurality of interviews, and the attribute estimation unit 104A estimates an attribute from each interview record. Then, the interview record and the attribute estimation result are recorded in the storage unit 11A or the like, for example, in a form such as the interview data 504 illustrated in FIG. 5.

In S11 (data acquisition processing), the data acquisition unit 101A acquires an interview record recorded for the target interview to be checked. The data acquisition unit 101A also acquires an estimation result of the attribute from the interview record of the target interview. For example, the data acquisition unit 101A may acquire information such as an interview record of the target interview from the interview data 504 illustrated in FIG. 5.

The number of the target interview may be one or more. For example, the data acquisition unit 101A may acquire an interview record of an interview ID designated by the user as an interview record of a target interview. Furthermore, for example, the data acquisition unit 101A may receive an input of a condition of the target interview by the user and acquire an interview record of an interview that satisfies the condition as an interview record of the target interview.

In S12, the search unit 105A searches for the interview record of the associated interview associated with the target interview based on the interview record acquired in S11. As described above, what kind of interview is to be an associated interview may be determined in advance.

In S13, the check unit 102A generates a prompt for instructing to check the interview record of the target interview acquired in S11. For example, the check unit 102A may generate a prompt by incorporating the interview record acquired in S11 and the interview record of the associated interview detected in S12 into a predetermined template. FIG. 8 illustrates an example of generating a prompt for instructing to check the interview record and create a report indicating the check result.

In S14 (check processing), the check unit 102A checks the interview record acquired in S11 using the language model 3A subjected to machine learning to enable natural language processing. More specifically, the check unit 102A inputs the prompt generated in S13 to the language model 3A based on the interview record acquired in S11. As a result, the language model 3A performs the check, and a report indicating the check result is output from the language model 3A.

In S15, the presentation control unit 107A presents the report indicating the check result of S14, that is, the report generated by the language model 3A in the processing of S14 to the user. Accordingly, the process in FIG. 8 is ended. After S14 or S15, the update unit 106A may update the interview record.

### MODIFIED EXAMPLE

An executing entity of each processing described in the above-described exemplary example embodiments is optional, and is not limited to the above-described examples. For example, a system having functions similar to those of the information processing devices 1 and 1A can be constructed by a plurality of devices capable of communicating with each other. The executing entity of each processing illustrated in the flowchart of FIG. 8 may be one device (may be rephrased as a processor) or a plurality of devices (may be similarly rephrased as processors).

### IMPLEMENTATION EXAMPLE BY SOFTWARE

Some or all of the functions of the information processing devices 1 and 1A (hereinafter, also referred to as “each of the above devices”) may be implemented by hardware such as an integrated circuit (IC chip) or may be implemented by software.

In the latter case, each of the above devices is implemented by, for example, a computer that executes commands of a program, that is software for implementing each of the functions. FIG. 9 illustrates an example of such a computer (hereinafter, referred to as a computer C). FIG. 9 is a block diagram illustrating a hardware configuration of the computer C functioning as each of the above devices.

The computer C includes at least one processor C1 and at least one memory C2. A program (check program) P for operating the computer C as each of the above devices is recorded in the memory C2. In the computer C, by the processor C1 reading the program P from the memory C2 and executing the program P, each of the functions of each of the above devices is implemented.

As the processor C1, for example, a Central Processing Unit (CPU), a Graphic Processing Unit (GPU), a Digital Signal Processor (DSP), a Micro Processing Unit (MPU), a Floating point number Processing Unit (FPU), a Physics Processing Unit (PPU), a Tensor Processing Unit (TPU), a quantum processor, a microcontroller, a combination thereof or the like can be used. As the memory C2, for example, a flash memory, a Hard Disk Drive (HDD), a Solid State Drive (SSD), or a combination of these can be used.

The computer C may further include a Random Access Memory (RAM) for loading the program P at the time of execution and temporarily storing various types of data. The computer C may further include a communication interface for transmitting and receiving data to and from another device. The computer C may further include an input/output interface for connecting input/output devices such as a keyboard, a mouse, a display, and a printer.

The program P can be recorded in a non-transitory tangible recording medium M readable by the computer C. As such a recording medium M, for example, a tape, a disk, a card, a semiconductor memory, a programmable logic circuit, or the like can be used. The computer C can acquire the program P via such a recording medium M. The program P can be transmitted via a transmission medium. As such a transmission medium, for example, a communication network, a broadcast wave, or the like can be used. The computer C can also acquire the program P via such a transmission medium.

Each of the above functions of each of the above devices may be implemented by a single processor provided in a single computer, may be implemented in cooperation by a plurality of processors provided in a single computer, or may be implemented in cooperation by a plurality of processors provided in a plurality of computers. The program for causing each of the above devices to achieve each of the above functions may be stored in a single memory provided in a single computer, may be stored in a distributed manner in a plurality of memories provided in a single computer, or may be stored in a distributed manner in a plurality of memories provided in a plurality of computers.

### SUPPLEMENTARY INFORMATION

The present disclosure includes the technologies described in the following Supplementary Notes. However, the present invention is not limited to the technologies described in the following supplementary notes, and various modifications can be made within the scope described in the claims.

### Supplementary Note A1

An information processing device including a data acquisition means for acquiring an interview record recorded for a target interview to be checked, and a check means for checking the interview record acquired by the data acquisition means using a language model subjected to machine learning to enable natural language processing.

### Supplementary Note A2

The information processing device according to supplementary note A1, further including an update means for updating the interview record according to a result of the check by the check means.

### Supplementary Note A3

The information processing device according to supplementary note A2, in which the update means causes a machine-learned generation model to generate an interview record of the target interview by using a prompt for instructing generation of an interview record reflecting a result of the check by the check means, and sets the generated interview record as an updated interview record.

### Supplementary Note A4

The information processing device according to any one of supplementary notes A1 to A3, further including a search means for searching for an interview record of an associated interview associated with the target interview, in which the check means causes the language model to perform a check based on the interview record of the associated interview detected by the search means.

### Supplementary Note A5

The information processing device according to supplementary note A4, in which the check means causes the language model to perform a check from a viewpoint of consistency between a speech and behavior in the target interview and a speech and behavior in the associated interview.

### Supplementary Note A6

The information processing device according to any one of supplementary notes A1 to A5, further including an attribute estimation means for estimating an attribute of a participant in the target interview, in which the check means causes the language model to perform a check based on the attribute of the participant estimated by the attribute estimation means.

### Supplementary Note A7

The information processing device according to any one of supplementary notes A1 to A6, in which the check means causes the language model to generate support information indicating at least one of a check result of the content of the target interview, a check result of a form of an interview report of the target interview, or an improvement measure of the target interview.

### Supplementary Note A8

The information processing device according to any one of supplementary notes A1 to A7, in which the check means causes the language model to generate a prompt for instructing to generate an interview record based on the content of the target interview as a check result of the interview record of the target interview, and an interview record generation means for causing a machine-learned generation model to generate next and subsequent interviews held by a participant common to the target interview by using the generated prompt is further provided.

### Supplementary Note B1

A check method in which at least one processor executes data acquisition processing of acquiring an interview record recorded for a target interview to be checked, and check processing of checking the interview record acquired in the data acquisition processing using a language model subjected to machine learning to enable natural language processing.

### Supplementary Note B2

The check method according to supplementary note B1, in which the at least one processor includes update processing of updating the interview record according to a result of the check by the check processing.

### Supplementary Note B3

The check method according to supplementary note B2, in which in the update processing, the at least one processor causes a machine-learned generation model to generate an interview record of the target interview by using a prompt for instructing generation of an interview record reflecting a result of the check in the check processing, and sets the generated interview record as an updated interview record.

### Supplementary Note B4

The check method of any of supplementary notes B1 to B3, in which the at least one processor includes search processing of searching for an interview record of an associated interview associated with the target interview, and in the check processing, the at least one processor causes the language model to perform a check based on the interview record of the associated interview detected in the search processing.

### Supplementary Note B5

The check method according to supplementary note B4, in which in the check processing, the at least one processor causes the language model to perform a check from a viewpoint of consistency between a speech and behavior in the target interview and a speech and behavior in the associated interview.

### Supplementary Note B6

The check method according to any one of supplementary notes B1 to B5, in which the at least one processor includes an attribute estimation processing of estimating an attribute of a participant in the target interview, and in the check processing, the at least one processor causes the language model to perform a check based on the attribute of the participant estimated in the attribute estimation processing.

### Supplementary Note B7

The check method according to any one of supplementary notes B1 to B6, in which in the check processing, the at least one processor causes the language model to generate support information indicating at least one of a check result of the content of the target interview, a check result of a form of an interview report of the target interview, or an improvement measure of the target interview.

### Supplementary Note B8

The check method according to any one of supplementary notes B1 to B7, in which in the check processing, the at least one processor causes the language model to generate a prompt for instructing to generate an interview record based on the content of the target interview as a check result of the interview record of the target interview, and interview record generation processing is further provided in which the at least one processor causes a machine-learned generation model to generate interview records of next and subsequent interviews held by a participant common to the target interview by using the generated prompt.

### Supplementary Note C1

A check program for causing a computer to function as a data acquisition means for acquiring an interview record recorded for a target interview to be checked, and a check means for checking the interview record acquired by the data acquisition means by using a language model subjected to machine learning to enable natural language processing.

### Supplementary Note C2

The check program according to supplementary note C1, further causing the computer to function as an update means for updating the interview record according to a result of the check by the check means.

### Supplementary Note C3

The check program according to supplementary note C2, in which the update means causes a machine-learned generation model to generate an interview record of the target interview by using a prompt for instructing generation of an interview record reflecting a result of the check by the check means, and sets the generated interview record as an updated interview record.

### Supplementary Note C4

The check program according to any one of supplementary notes C1 to C3, further causing the computer to function as a search means for searching for an interview record of an associated interview associated with the target interview, in which the check means causes the language model to perform a check based on the interview record of the associated interview detected by the search means.

### Supplementary Note C5

The check program according to supplementary note C4, in which the check means causes the language model to perform a check from a viewpoint of consistency between a speech and behavior in the target interview and a speech and behavior in the associated interview.

### Supplementary Note C6

The check program according to any one of supplementary notes C1 to C5, further causing the computer to function as an attribute estimation means for estimating an attribute of a participant in the target interview, in which the check means causes the language model to perform a check based on the attribute of the participant estimated by the attribute estimation means.

### Supplementary Note C7

The check program according to any one of supplementary notes C1 to C6, in which the check means causes the language model to generate support information indicating at least one of a check result of the content of the target interview, a check result of a form of an interview report of the target interview, or an improvement measure of the target interview.

### Supplementary Note C8

The check program according to any one of supplementary notes C1 to C7, in which the check means causes the language model to generate a prompt for instructing to generate an interview record based on the content of the target interview as a check result of the interview record of the target interview, and the computer is caused to function as an interview record generation means for causing a machine-learned generation model to generate interview records of next and subsequent interviews held by a participant common to the target interview by using the generated prompt.

### Supplementary Note D1

An information processing device including at least one processor, in which the at least one processor executes data acquisition processing of acquiring an interview record recorded for a target interview to be checked, and check processing of checking the interview record acquired in the data acquisition processing using a language model subjected to machine learning to enable natural language processing.

The information processing device may further include a memory. The memory may store a program for causing the at least one processor to execute each of the processing.

### Supplementary Note D2

The information processing device according to supplementary note D1, in which the at least one processor executes update processing of updating the interview record according to a result of the check by the check processing.

### Supplementary Note D3

The information processing device according to supplementary note D2, in which in the update processing, the at least one processor causes a machine-learned generation model to generate an interview record of the target interview by using a prompt for instructing generation of an interview record reflecting a result of the check in the check processing, and sets the generated interview record as an updated interview record.

### Supplementary Note D4

The information processing device according to any of supplementary notes D1 to D3, in which the at least one processor executes search processing of searching for an interview record of an associated interview associated with the target interview, and in the check processing, the at least one processor causes the language model to perform a check based on the interview record of the associated interview detected in the search processing.

### Supplementary Note D5

The information processing device according to supplementary note D4, in which in the check processing, the at least one processor causes the language model to perform a check from a viewpoint of consistency between a speech and behavior in the target interview and a speech and behavior in the associated interview.

### Supplementary Note D6

The information processing device according to any one of supplementary notes D1 to D5, in which the at least one processor executes an attribute estimation processing of estimating an attribute of a participant in the target interview, and in the check processing, the at least one processor causes the language model to perform a check based on the attribute of the participant estimated in the attribute estimation processing.

### Supplementary Note D7

The information processing device according to any one of supplementary notes D1 to D6, in which in the check processing, the at least one processor causes the language model to generate support information indicating at least one of a check result of the content of the target interview, a check result of a form of an interview report of the target interview, or an improvement measure of the target interview.

### Supplementary Note D8

The information processing device according to any one of supplementary notes D1 to D7, in which in the check processing, the at least one processor causes the language model to generate a prompt for instructing to generate an interview record based on the content of the target interview as a check result of the interview record of the target interview, and the at least one processor further executes interview record generation processing of causing a machine-learned generation model to generate interview records of next and subsequent interviews held by a participant common to the target interview by using the generated prompt.

### Supplementary Note E

A non-transitory recording medium storing a check program for causing a computer to function as an information processing device, the program causing the computer to execute data acquisition processing of acquiring an interview record recorded for a target interview to be checked, and check processing of checking the interview record acquired in the data acquisition processing by using a language model subjected to machine learning to enable natural language processing.

What is claimed is:

1. An information processing device comprising:
at least one memory storing instructions, and
at least one processor configured to execute the instructions to:
acquire an interview record recorded for a target interview to be checked, and
check the interview record acquired using a language model subjected to machine learning to enable natural language processing.

2. The information processing device according to claim 1, wherein the at least one processor is further configured to execute the instructions to update the interview record according to a result of the check .

3. The information processing device according to claim 2, wherein the at least one processor is further configured to execute the instructions to cause a machine-learned generation model to generate an interview record of the target interview by using a prompt for instructing generation of an interview record reflecting a result of the check, and set the generated interview record as an updated interview record.

4. The information processing device according to claim 1, wherein the at least one processor is further configured to execute the instructions to search for an interview record of an associated interview associated with the target interview,
cause the language model to perform a check based on the interview record of the associated interview detected.

5. The information processing device according to claim 4, wherein the at least one processor is further configured to execute the instructions to cause the language model to perform a check from a viewpoint of consistency between a speech and behavior in the target interview and a speech and behavior in the associated interview.

6. The information processing device according to claim 1, wherein the at least one processor is further configured to execute the instructions to estimate an attribute of a participant in the target interview,
cause the language model to perform a check based on the attribute of the participant estimated.

7. The information processing device according to claim 1, wherein the at least one processor is further configured to execute the instructions to cause the language model to generate support information indicating at least one of a check result of the content of the target interview, a check result of a form of an interview report of the target interview, or an improvement measure of the target interview.

8. The information processing device according to claim 1, wherein
wherein the at least one processor is further configured to execute the instructions to cause the language model to generate a prompt for instructing to generate an interview record based on the content of the target interview as a check result of the interview record of the target interview, and
cause a machine-learned generation model to generate next and subsequent interviews held by a participant common to the target interview by using the generated prompt is further provided.

9. A check method implemented by at least one processor, comprising
acquiring an interview record recorded for a target interview to be checked, and
checking the interview record acquired in the data acquisition processing using a language model subjected to machine learning to enable natural language processing.

10. The information processing method according to claim 9, further comprising updating the interview record according to a result of the check.

11. The information processing device according to claim 10, further comprising causing a machine-learned generation model to generate an interview record of the target interview by using a prompt for instructing generation of an interview record reflecting a result of the check, and setting the generated interview record as an updated interview record.

12. The information processing method according to claim 9, further comprising searching for an interview record of an associated interview associated with the target interview,
causing the language model to perform a check based on the interview record of the associated interview detected.

13. The information processing method according to claim 12, further comprising causing the language model to perform a check from a viewpoint of consistency between a speech and behavior in the target interview and a speech and behavior in the associated interview.

14. The information processing method according to claim 9, further comprising estimating an attribute of a participant in the target interview,
causing the language model to perform a check based on the attribute of the participant estimated.

15. A non-transitory computer readable medium storing a check program for causing a computer to execute processing of acquiring an interview record recorded for a target interview to be checked, and
checking the interview record acquired by using a language model subjected to machine learning to enable natural language processing.

16. The non-transitory computer readable medium according to claim 15, the processing further comprising updating the interview record according to a result of the check .

17. The non-transitory computer readable medium according to claim 16, the processing further comprising causing a machine-learned generation model to generate an interview record of the target interview by using a prompt for instructing generation of an interview record reflecting a result of the check, and setting the generated interview record as an updated interview record.

18. The non-transitory computer readable medium according to claim 15, the processing further comprising searching for an interview record of an associated interview associated with the target interview,
causing the language model to perform a check based on the interview record of the associated interview detected.

19. The non-transitory computer readable medium according to claim 18, the processing further comprising causing the language model to perform a check from a viewpoint of consistency between a speech and behavior in the target interview and a speech and behavior in the associated interview.

20. The non-transitory computer readable medium according to claim 15, the processing further comprising estimating an attribute of a participant in the target interview,
cause the language model to perform a check based on the attribute of the participant estimated.
